(19) United States
(12) Patent Application Publication
(10) Pub. No.: US 2022/0412654 A1
(43) Pub. Date: Dec. 29, 2022

(54) DEVICE FOR HEAT TREATMENT OF A PRODUCT COMPRISING AT LEAST ONE HEATING ELEMENT AND CORRESPONDING METHOD

(71) Applicant: E.T.I.A. - EVALUATION TECHNOLOGIQUE, INGENIERIE ET APPLICATIONS, COMPIEGNE CEDEX (FR)

(72) Inventors: Olivier LEPEZ, SAINT-CYR-SUR-MER (FR); Philippe SAJET, LACROIX SAINT-OUEN (FR)

(21) Appl. No.: 17/764,001

(22) PCT Filed: Jun. 23, 2020
(86) PCT No.: PCT/EP2020/067397

§ 371 Date: Mar. 25, 2022

(30) Foreign Application Priority Data
Oct. 8, 2019 (FR) FR1911157

(51) Int. Cl. F27B 9/36; F27B 9/06; F27D 3/08; F27D 11/02; F26B 23/06; F26B 17/20; F26B 3/24

(52) U.S. Cl. CPC F27B 9/36; F27B 9/065; F27D 3/08; F27D 11/02; F26B 23/06; F26B 17/20; F26B 3/24

(57) ABSTRACT

The invention relates to a device for heat treatment of a product, including: an enclosure comprising a casing made of refractory material; a screw mounted to turn in the casing about a geometric axis of rotation in order to move the product between an inlet of the casing and an outlet of the casing, the screw furthermore forming a heating means for heat treatment of the product by supplying electricity to the screw. According to the invention, the device comprises at least one heating element for heating the casing in operation, the heating element being arranged inside at least one of the walls of the casing. The invention also relates to a corresponding method.

The present invention relates to a heat treatment device.

The present invention also relates to a method of applying heat treatment to a substance as performed by such a device.

### BACKGROUND OF THE INVENTION

The heat treatment devices commonly used in industry generally comprise a transfer member and heater means performing the heat treatment.

In its patent EP 2 218 300, the present applicant has thus proposed a heat treatment device that includes an enclosure and conveyor means for conveying the substance between the inlet of the enclosure and the outlet of the enclosure, which conveyor means comprise a screw mounted to rotate inside the enclosure about an axis of rotation and means for driving the screw in rotation. The device also includes heater means for heating the screw by the Joule effect.

The substance for treatment is usually inserted into the inlet of the enclosure in the form of divided solids. The screw pushes the substance continuously towards the outlet of the enclosure. Because of the temperature of the screw, the substance is heated progressively as it advances, thereby subjecting it to heat treatment.

That type of device thus makes it possible to treat any type of substance effectively.

Nevertheless, such an arrangement does not always make it possible to envisage heat treatment at high temperatures.

In its patent EP 2 218 300 the present applicant has thus proposed having an enclosure presenting inside walls made of a refractory material, the screw constituting means for heating the inside walls so that said inside walls themselves constitute heater means for radiant heating of divided solids advancing inside the enclosure.

Under such circumstances, the substance is heated both by the screw and by the inside walls, thus enabling the substance to be worked at high temperatures.

Nevertheless, the screw must not itself be raised to temperatures that are too high, since otherwise it risks being damaged.

If the heat treatment of a substance give rise to the production both of a gas and also of residues, these tend to cool the screw down all along the enclosure, thereby limiting any excessive temperature rise of the screw.

However, if the heat treatment gives rise to little or no production of residues, the substance can no longer cool the screw down close to the outlet from the enclosure as a result of the substance being transformed into gas.

Consequently, in order to protect the screw, it is known to arrange a temperature sensor at the outlet from the enclosure and to interrupt the supply of electrical power to the screw momentarily whenever the temperature delivered by the sensor exceeds a setpoint temperature, so as to allow the screw time to cool down.

The drawback is that the portion of the screw closer to the outlet of the enclosure is also the portion that takes the longest to cool down. Consequently, electrical power is not always supplied again soon enough for the portion of the screw at the beginning of the enclosure to be hot enough to apply the heat treatment to the substance.

This tends to cause untreated substance to accumulate inside the enclosure and thus cause the screw to become blocked. This happens in particular when the substance, which is initially a solid and divided substance, passes through a stage of softening or even of partial melting on being subjected to high temperatures, thereby leading to the screw becoming blocked by being caught in the flow of molten and viscous substance. This applies in particular when the substance for treatment is a polymer.

### OBJECT OF THE INVENTION

An object of the invention is to propose a device for applying heat treatment to a substance while limiting any risk of the screw becoming blocked by the substance.

An object of the invention is to propose a method of applying heat treatment to a substance as performed by such a device.

### SUMMARY OF THE INVENTION

In order to achieve this object, there is provided a device for subjecting a substance to heat treatment, the device comprising:
an enclosure having a lining of refractory material;
a screw mounted to rotate inside the lining about an axis of rotation in order to move the substance between an inlet to the lining and an outlet from the lining, the screw also forming heater means for applying heat treatment to the substance when the screw is electrically powered.

According to the invention, the device includes at least one heater element for heating the lining in service, the heater element being arranged within at least one of the walls of the lining.

As a result, the heat treatment as applied to the substance by means of the screw can be topped up or replaced by means of the refractory lining having the heater element suitably arranged in the refractory lining.

This enables any risk of the screw becoming blocked by the substance to be limited by making use of the heater element for topping up and/or replacing the heat treatment applied to the substance by the screw, e.g. for the time it takes for the screw to cool down in the event of its electrical power supply being stopped temporarily.

Thus, the heat treatment of the substance can be continued with a solution that is also not very expensive in terms of energy.

The invention thus serves to optimize the quality and the area of the heating delivered to the inside of the lining.

Advantageously, the invention can be retrofitted to existing devices by drilling at least one of the walls of the lining in order to insert the heater element therein.

Also, since the heater element is arranged within one or more walls of the lining, it is protected from the atmosphere present inside the lining due to the heat treatment applied to the substance; which atmosphere may potentially be corrosive, depending on the substance being treated.

Optionally, the heater element is arranged at the inlet to the lining.

Optionally, the device includes only heater elements that are arranged at the inlet to the lining.

Optionally, the device includes at least one pair of heater elements extending in opposite sides of the lining.

Optionally, at least one heater element is arranged so as to extend in at least one of the side flanks of the lining.

Optionally, the device includes at least two heater elements extending parallel to each other and to the walls in which they extend.

Optionally, the device includes at least two heater elements extending vertically.

Optionally, the heater element extends over 75% to 95% of the height of the lining.

Optionally, the heater element is a resistance heater element.

Optionally, the heater element is a cartridge heater.

Optionally, the device includes a fastener plate for fastening heater elements to the enclosure.

Optionally, the plate includes at least one opening having arranged therein at least one strip with at least one orifice suitable for receiving at least one heater element.

Optionally, the device includes at least one measurement member for measuring the temperature within at least one of the walls of the lining.

Optionally, the device includes at least one control unit controlling at least the heater element on the basis of data exchanged with the measurement member.

Optionally, the device includes a tube connected firstly to the inlet of the lining and secondly to an air inlet in order to insert a controlled flow of air into the enclosure.

The invention also provides a method of applying heat treatment to a substance as performed by such a device, the method comprising the step of using the heater element while the screw is not being powered electrically.

Optionally, the substance inserted inside the lining is a substance that produces little or no residue when subjected to the heat treatment.

Optionally, the substance is a polymer material.

Other characteristics and advantages of the invention appear on reading the following description of a particular, nonlimiting embodiment of the invention.

### BRIEF DESCRIPTION OF THE DRAWINGS

The invention can be better understood in the light of the following description given with reference to the accompanying figures, in which:

FIG. 1 is a diagrammatic view of a device in a particular embodiment of the invention;

FIG. 2 is a diagrammatic cross-section view of the device shown in FIG. 1;

FIG. 3 is a perspective view of an enclosure of the device shown in FIG. 1.

### DETAILED DESCRIPTION OF THE INVENTION

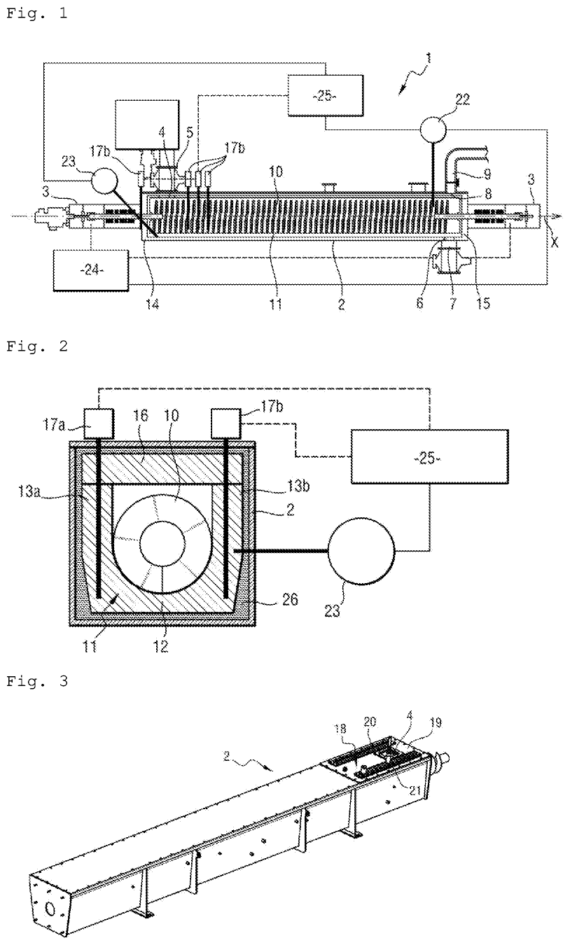

FIG. 1 shows a device in a particular embodiment of the invention, given overall reference 1, for applying heat treatment to a substance.

In this example, the device 1 is applicable to gasifying waste, e.g. plant matter waste or indeed polymer waste, in order to produce a synthesis gas, or indeed methane gas or else dihydrogen.

Naturally, this application is not limiting, and the device 1 could be used for numerous other applications. By way of example, mention may be made of heating, roasting, pyrolysis, gasification, devolatilization, desiccation, . . . .

The device 1 has an enclosure 2 extending generally in an essentially horizontal direction and held at a distance from the ground by legs.

In this example, the substance is inserted into the enclosure 2 in the form of divided solids. The divided solids may be in the form of powders, granules, pieces, fibers, sheets, . . . and they may be of vegetable, mineral, chemical, . . . origin. The substance may thus be of any type (wood, plastic, sludge, waste, . . . ).

The enclosure 2 has at least one inlet 4 arranged in the cover of the enclosure 2 substantially at a first longitudinal end of the enclosure 2. In a particular embodiment, the device includes an inlet tube 5 that is connected in sealed manner to the inlet 4 to the enclosure. By way of example, the inlet tube 5 is connected to a device for grinding, compacting, extruding, melting, weighing out, or granulating the substance under consideration in the form of divided solids. The inlet tube 5 may also be connected to an air inlet so as to improve gasification treatment by partial combustion of the substance inside the enclosure 2 resulting from controlled admission of air (and thus of oxygen). It should be observed that the substance is then inserted into the enclosure 2 via the same inlet tube 5 as the air.

The enclosure 2 also includes at least one first outlet 6 arranged in this example in the bottom of the enclosure 2 substantially at the second of the two longitudinal ends of the enclosure 2.

In a particular embodiment, the device includes a first outlet tube 7 that is connected in sealed manner to the first outlet 6 of the enclosure 2. By way of example, the first outlet tube 7 is connected to a device for cooling the substance or to a device for post-treatment of the substance.

In this example, the enclosure 2 has a second outlet 8 for recovering the gaseous by-products resulting from the heat treatment of the divided solids. The nature of the gaseous by-products in question depends on the type of treatment in question: it may thus be gas, smoke, steam, heavy metal, . . . .

In a particular embodiment, the device 1 includes an outlet tube 9 that is connected in sealed manner to the second outlet 8 of the enclosure 2. By way of example, the outlet tube 9 is connected to a device for post-treatment of the gaseous by-products, e.g. in order to purify said gaseous by-products.

In this example, the enclosure 2 presents a section that is rectangular.

By way of example, the enclosure 2 is made of metal. Typically, the enclosure 2 is made of steel, such as stainless steel, and for example it is non-magnetic.

Boxes 3 are fastened to each of the longitudinal ends of the enclosure 2.

The device 1 includes a screw 10 of longitudinal axis X that is mounted to rotate about said longitudinal axis X inside the enclosure 2, the longitudinal axis X in this example being parallel to the general direction of the enclosure 2. The longitudinal axis X is thus horizontal in this example.

Specifically, the screw 10 is in the form of a helical coil that is fastened at each of its two ends to the tip of a respective shaft segment, however this is naturally merely an example, and any other helical type geometrical configuration could be used.

The screw 10 thus does not itself have a shaft proper.

The other end of each shaft segment is connected to a shaft on the same axis that passes through the associated box.

Each box 3 is provided with means serving to drive the screw 10 in rotation, and with means for delivering electrical power to the screw 10 so that it constitutes Joule effect heater means. The screw 10 thus constitutes heating transfer means.

For this purpose, the bulk of the material constituting the screw 10 is electrically conductive.

The device also includes a lining 11 of refractory material that is arranged inside the enclosure. In reality, the screw 10 extends directly inside of the lining 11, which is thus itself arranged inside the enclosure 2. More precisely, in this example the screw 10 rests on a bottom 12 of the lining 11.

In addition to its functions of directly heating substances that come into contact therewith and of transferring said substances longitudinally, the screw 10 also heats the lining 11 that thus itself provides radiant heating to the mass of divided solids.

The lining 11 presents a general direction that is essentially horizontal, coinciding with or parallel to the general direction of the enclosure 2. More precisely, the lining 11 extends between the inlet and outlet of the enclosure 2, and in corresponding manner it has an inlet 4 and two outlets 6 and 8 for connecting the inlet tube 5 and the two outlet tubes 7 and 9 to the lining 11. The substance thus travels inside the enclosure 2 through the lining 11.

In the present example, the lining 11 has the above-mentioned bottom 12 extended by two side flanks 13a and 13b, a lining ceiling 16, and front and rear walls 15 and 14 closing the lining.

Preferably, the lining 11 is also shaped in such a manner that at least a portion of the internal outline of the lining 11 follows the external outline of the screw 10.

In the present example, only the bottom 12 closely matches the outline of the screw 10, which rests thereon.

As a result, any gap between the screw 10 and the lining 11 is limited in the bottom portion of the lining.

Because the bulk of the screw 10 is constituted by an electrically conductive material, and because it is connected to at least one electrical power supply, it is preferable for the lining 11 to be made of a material that is both refractory and also electrically insulating. By way of example, it may be made of a refractory concrete or of a refractory ceramic material such as those commonly used for making furnace walls. Such materials have melting points that are very high and in particular higher than 2000° C. By way of example, the lining 12 may be based on alumina (Al₂O₃).

In the present example, the tubes 5, 7, 9 are preferably likewise made of refractory material of the same kind as the material of the lining 11.

In a preferred embodiment, the enclosure 2 and the lining 11 are not in contact with each other.

Thus, the device 1 includes an intermediate blanket 26 made of thermally insulating material extending between the lining 11 and the enclosure 2. By way of example, the blanket is made of rock wool or of a more technical material that is better at withstanding very high temperatures.

In accordance with the invention, the device 1 includes at least one heater element arranged in at least one of the walls of the lining 11.

Preferably, the device 1 includes at least a pair of heater elements 17a and 17b. In this example, the device includes one to six pairs of heater elements, and preferably two to five pairs of heater elements.

By way of example, at least one heater element is arranged so as to extend in at least one of the flanks of the lining.

In the present example, each of the heater elements 17a and 17b in a given pair are arranged in respective ones of the flanks 13a and 13b of the lining 11 so as to face each other.

The heater elements 17a and 17b thus occupy the sides of the lining 11 on opposite sides thereof.

Preferably, both heater elements 17a and 17b of a given pair are located at the same distance along the general direction of the lining 11 (which direction coincides with or is parallel to the longitudinal axis X).

The pairs of heater elements are regularly spaced apart from one another along the general direction of the lining 11.

The heater elements of a given side of the lining 11 occupy a segment presenting a length (i.e. the distance between the two heater elements at the ends of the segment) that lies in the range 5% to 25% of the total length of the lining 11, and typically in the range 10% to 20%. Preferably, the segment begins at the front wall 14 of the lining 11, with the heater elements 17a and 17b thus being arranged at the front of the lining 11, and preferably around the inlet 4 of the lining 11.

Thus, the heater elements 17a and 17b are arranged in the upstream portion of the lining 11.

In the present example, a first pair of heater elements 17a and 17b is arranged at the very beginning of the lining 11 upstream from the inlet 4 of the lining 11. A second pair of heater elements 17a and 17b (not shown) is preferably arranged level with the inlet 4, on opposite sides thereof. The remaining pairs of heater elements 17a and 17b are arranged thereafter.

In this example, the heater elements 17a and 17b are all identical. In a variant, the heater elements 17a and 17b need not all be identical with one another. For example, the heater elements could be configured to heat the lining 11 differently depending on their locations.

Each heater element 17a or 17b extends in a straight line.

The heater elements 17a and 17b preferably extend parallel to one another. In this example, the heater elements 17a and 17b extend substantially vertically.

Preferably, the heater elements 17a and 17b extend not only in the flanks 13a and 13b of the lining 11, but also in part in its bottom 12. Nevertheless, the heater elements 17a and 17b do not project out from the bottom 12 nor even from the flanks 13a or 13b.

Thus, in this example, the heater elements 17a and 17b extend over 75% to 95% of the height of the lining 11 and preferably over 80% to 95% of said height.

In contrast, the heater elements 17a and 17b do project out from the ceiling 16 of the lining 11, and also from the enclosure 2 at this position.

Specifically, in this example, the heater elements 17a and 17b are resistance heater elements. Said heater elements 17a and 17b are thus connected to an electrical power supply so that the heater elements 17a and 17b can constitute means for heating the lining by the Joule effect. For this purpose, the heater elements 17a and 17b are connected to the electrical power supply via their ends projecting out from the ceiling 16.

In the event that the heater elements are not identical with one another, they could present resistances that are different.

In this example, each heater element is a cartridge heater. Each heater element is thus in the shape of a tube of section that is square, round, rectangular, . . . .

Optionally, each heater element is a boron nitride cartridge heater.

Such cartridges are well known to the person skilled in the art and they are therefore not described in detail herein.

In a particular embodiment, and as can be seen more clearly in FIG. 3, the enclosure 2 includes a plate 18 for fastening the heater elements 17a and 17b to the enclosure 2.

Typically, the plate 18 has a base 19 for securing to the ceiling of the enclosure, or itself constitutes all or part of the ceiling. Typically, the base 19 includes two openings 20 that extend in straight lines on opposite sides of the inlet 4, and parallel to the longitudinal direction X. In this example, each opening 20 presents a section that is rectangular.

In corresponding manner, the plate 18 includes two strips 21 (only one of which is shown), each of which is arranged in a respective one of the openings 20 in the base 19 so as to cover said openings.

Each strip 21 includes a succession of orifices that are regularly distributed along the strip 21 so as to form a row parallel to the longitudinal direction X. Each orifice is also suitable for receiving a respective one of the heater elements 17a or 17b.

The strips 21 thus serve to facilitate arranging the heater elements 17a and 17b in the lining 11.

In particular, if the device 1 did not initially have provision for heater elements 17a, 17b, then placing the plate 18 on the ceiling of the enclosure makes it easy to see where holes need to be drilled in the lining 11 in order to be able to insert the heater elements 17a, 17b therein: in register with one, some, or all of the orifices in one or both strips 21.

Advantageously, one or more gaskets may be arranged in association with the plate 18 so as to provide thermal sealing between the outside and the inside of the lining 11. Typically, a gasket may be arranged between at least one of the strips 21 and the corresponding opening 20, or in association with each orifice of at least one of the strips 21.

This limits any risk of losing heat.

In a particular embodiment, the heater elements 17a, 17b are powered electrically from an electrical power supply that is different from the power supply of the screw 10. Consequently, the device 1 has the above-mentioned first power supply means of the device 1 for powering the screw 10, and second power supply means for powering the heater elements 17a and 17b, which second power supply means are distinct from the first power supply means.

Preferably, in order to control the various power supply means, the device 1 includes a first measurement member 22 for measuring the temperature inside the lining 11. By way of example, the first member 22 is a temperature sensor.

Preferably, the first member 22 is arranged to measure temperature at the outlet from the lining 11.

In this example, the first member 22 is arranged to measure temperature at the screw 10, and preferably at the center of the turns of the screw 10.

Preferably, the device 1 includes a second member 23 for measuring the temperature in the walls of the enclosure 11. By way of example, the second member 23 is a temperature sensor.

Preferably, the second member 23 is arranged to measure temperature at the inlet 4 to the lining 11.

In this example, the second member 23 is arranged to measure temperature at one of the heater elements 17a or 17b.

The device 1 includes a first control unit 24 for controlling the screw 10 by controlling at least the electrical power supplied to the screw 10 as a function of data delivered at least by the first measurement member 22. By way of example, the first control unit 24 comprises calculation means, a computer, a microprocessor, . . . .

The screw 10 is thus controlled to deliver a setpoint temperature (e.g. 700° C.) regulated on the basis of the temperature measured by the first measurement member 22, which is representative of the hottest zone of the screw 10.

Also, the device 1 includes a second control unit 25 for controlling the heater elements 17a and 17b by controlling at least the electrical power supplied to heater elements 17a and 17b as a function of data delivered at least by the second measurement member 23. By way of example, the second control unit 25 comprises calculation means, a computer, a microprocessor, . . . .

Preferably, the second control unit 25 for controlling the heater elements 17a and 17b controls at least the electrical power supplied to heater elements 17a and 17b as a function of data delivered at least by the second measurement member 25 and at least by the first measurement member 24.

The heater elements 17a and 17b are thus controlled to comply with a setpoint temperature regulated on the temperature measured by the first measurement member 22 and representative of the hottest zone of the screw, and on the temperature measured by the second measurement member 23 and representative of the temperature of the lining 11 at the inlet to the screw 10, i.e. the coolest zone of the screw 10.

By way of example, the various control units 24 and 25 may be arranged in the boxes 3 of the device 1, as are the various power supply means.

Thus, in service, the screw 10 is powered so that the first power supply means are stopped when the temperature of the screw 10 at the outlet from the lining 11 exceeds a setpoint temperature.

This limits any risk of damage to the screw 10.

Nevertheless, the temperature at the inlet to the lining 11 is also controlled by the second measurement member 23: if it drops below a given temperature while the temperature at the outlet from the screw 10 has not yet come down, then the second control unit 25 causes the second power supply means to power the heater elements 17a and 17b. These heat the inlet 4 of the lining 11 so that the lining 11 continues to provide sufficient heat to ensure heat treatment of the substance, thereby avoiding substance accumulating at the inlet 4 of the lining 11.

It should be observed that the lining 11 thus contributes specifically to heating the substance, with the heater elements 17a and 17b not serving merely to maintain the lining 11 at a suitable temperature.

Once the temperature at the outlet from the lining 11 has come back down to an acceptable value, the first power supply means are controlled once more to supply power to the screw 10 and the second heater means are stopped.

This serves in simple and effective manner to provide very good continuous heat treatment of the substance while not subjecting the screw 10 to excessive stress. In particular, the heater elements 17a and 17b tend to ensure that the temperature of the screw 10 is uniform all along its length.

Such a device 1 and such a method are particularly advantageous when the substance that is inserted into the lining 11 produces little or no residue at the outlet from the lining 11. Specifically, under such circumstances, the substance cannot cool the screw 10 naturally and cannot prevent too great a temperature difference between the inlet and the outlet from the enclosure 2.

The term “a substance that produces little or no residue” is used to mean a substance for which 100 parts by weight of the substance at the inlet to the lining 11 give rise to less than 10 parts by weight of residue (i.e. of solid elements) at the outlet from the lining 11, with much the greater fraction of the substance being transformed into gas.

By way of example, this applies to a substance of polymer type, and more particularly to a plastics material.

The invention is not limited to the embodiment described above, but on the contrary covers any variant using equivalent means to reproduce the essential characteristics set out above.

In particular, the device could have some number of heater elements other than that specified. The heater elements could be arranged in a manner different from that specified. By way of example, at least one heater element could be arranged at least in the ceiling of the lining or in the bottom of the lining. Thus, at least one heater element could be arranged substantially horizontally in the enclosure. The element need not be arranged vertically or horizontally, but could be inclined relative to the vertical and to the horizontal. Thus, the heater element could be arranged within at least one of the walls of the lining parallel to the faces of said wall.

The element need not extend in a straight-line manner.

The heater elements could be arranged differently in the lining, and for example they could be distributed all along the lining and not only at the beginning of the lining.

The heater elements could also be different from those specified. Thus, although above the heater element is a boron nitride cartridge heater, the heater element could be a magnesium oxide cartridge heater. Equally, the heater element need not be a cartridge heater, but could be a heater plate or indeed a spark plug. The heater element could equally well not be based on a heating resistance element as mentioned above, but could be a pipe conveying a hot fluid. In general manner, the heater element could be any element that enables the lining to be heated sufficiently to keep the temperature high enough to perform the heat treatment of the substance, at least at the inlet of the enclosure.

It is possible to omit the plate for fastening the heater elements, or else to select plate of a different shape.

The various heater elements could be controlled differently from one another instead of all of them being controlled in the same manner, as described.

The heater element and the screw could be powered from the same electrical power supply. Consequently, the device could have the same power supply means both for the screw and also for the heater elements.

Likewise, the heater element and the screw could be controlled by the same control unit. Consequently, the device could have the same control unit both for the screw and also for the heater elements. By way of example, the control unit could apply a control relationship based on a given temperature from which the heater elements are activated, said temperature corresponding to a percentage of the temperature measured at the outlet from the lining.

It would also be possible to have a number of measurement members other than that described and/or to have measurement members that are different, such as members for measuring pressure, humidity, speed of rotation, the presence or absence of residue at the inlet to the lining, . . . . Each unit could thus control the heater element in question while using a number of measurement members other than that described. The measurement members could be arranged at locations other than those described. Thus, the measurement member at the inlet to the lining could be arranged to measure the temperature inside the lining and not within the walls of the lining.

Although above it is proposed to make use of the heater elements only while the screw is not being powered, it is possible to envisage using the heater elements differently. In particular, the heater elements could be used to top up the heating provided by the screw, either in order to heat to a higher temperature or else to limit the amount of power that is supplied to the screw.

The heater elements could also be used to assist in initiating the heat treatment. For example, the process could begin by heating the lining so that heat is spread inside the lining in uniform manner, with the outside walls of the lining being protected by the covering of thermally insulating material.

Furthermore, the screw could be different from that described. In particular, the screw could present resistance that varies along with the axis of the screw, as proposed in the present applicant's patent FR 2 995 986.

Also, although above the lining is described as being in one piece, the lining could be made up of a succession of segments, which could optionally interfit in one another. Likewise, the flanks, the bottom, and the ceiling could be separate pieces that are fitted to one another in order to form at least one segment of the lining.

The lining could be of a shape other than that described, and for example it could present a section such that the inside surface of the lining is rectangular or square and does not have a recessed bottom for fitting closely to the shape of the screw as in patent EP 2 218 300. On the contrary, the lining could surround the screw completely so as to define a space between the screw and the lining as in the present applicant's application PCT/EP2019/058815. The flanks of the lining could be inclined relative to the vertical and horizontal (and not straight as described above).

The blanket need not be a single piece, but could be made up of a plurality of elements that are fastened to one another and/or fastened to the lining and/or fastened to the enclosure. It is possible to do without a blanket.

Furthermore, although above the substance is inserted into the enclosure in the form of divided solids, the substance could be inserted in some other form, e.g. liquid or even gaseous. In the same manner, it is possible to recover one or more substances at the outlet in the form of a gas, a liquid, an oil, a solid, . . . . The number of inlets and outlets of the enclosure should be adjusted accordingly.

If the device includes an inlet tube enabling the air to be inserted in controlled manner into the enclosure, the substance could be inserted into the enclosure either via the same tube or else via another inlet tube.

Among the possible applications of the invention, it should also be observed that the heat treatment device could be installed downstream from a conventional pyrolysis installation so as to treat the char coming from the pyrolysis in order to subject it to post-treatment, or indeed it could be installed downstream from a device for pre-conditioning the substance in question. By way of example, a pre-conditioning device could serve to heat and dry said substance to specified values of temperature and relative humidity, or else to densify the substance, or else to moisten the substance, or else to extract interstitial air by partial or total melting, or else to insert air into the enclosure in controlled manner so as to accentuate and enhance an operation of gasifying the substance for treatment.

1. A device for subjecting a substance to heat treatment, the device comprising:
an enclosure having a lining of refractory material;
a screw mounted to rotate inside the lining about an axis of rotation in order to move the substance between an inlet to the lining and an outlet from the lining, the screw also forming heater means for applying heat treatment to the substance when the screw is electrically powered;
the device being characterized in that it includes at least one heater element for heating the lining in service, the heater element being arranged within at least one of the walls of the lining.

2. The device according to claim 1, wherein the heater element is arranged at the inlet to the lining.

3. The device according to claim 2, including only heater elements that are arranged at the inlet to the lining.

4. The device according to claim 1, including at least one pair of heater elements extending in opposite sides of the lining.

5. The device according to claim 1, wherein at least one heater element is arranged so as to extend in at least one of the side flanks of the lining.

6. The device according to claim 1, including at least two heater elements extending parallel to each other and to the walls in which they extend.

7. The device according to claim 1, including at least two heater elements extending vertically.

8. The device according to claim 1, wherein the heater element extends over 75% to 95% of the height of the lining.

9. The device according to claim 1, wherein the heater element is a resistance heater element.

10. The device according to claim 9, wherein the heater element is a cartridge heater.

11. The device according to claim 1, including a fastener plate for fastening heater elements to the enclosure.

12. The device according to claim 11, wherein the plate includes at least one opening having arranged therein at least one strip with at least one orifice suitable for receiving at least one heater element.

13. The device according to claim 1, including at least one measurement member for measuring the temperature within at least one of the walls of the lining.

14. The device according to claim 12, including at least one control unit controlling at least the heater element on the basis of data exchanged with the measurement member.

15. The device according to claim 1, including a tube connected firstly to the inlet of the lining and secondly to an air inlet in order to insert a controlled flow of air into the enclosure.

16. A method of applying heat treatment to a substance, the method being performed by a device according to claim 1, the method comprising the step of using the heater element while the screw is not being powered electrically.

17. The method according to claim 16, wherein the substance inserted inside the lining is a substance that produces little or no residue when subjected to the heat treatment.

18. The method according to claim 17, wherein the substance is a polymer material.
